(19) United States
(12) Patent Application Publication
(10) Pub. No.: US 2009/0169067 A1
(43) Pub. Date: Jul. 2, 2009

(54) FACE DETECTION AND TRACKING METHOD

(75) Inventors: Yin-Pin CHANG, Taipei City (TW); Tai-Chang YANG, Fongshan City (TW); Hong-Long CHOU, Taipei (TW)

Correspondence Address: Workman Nydegger;1000 Eagle Gate Tower, 60 East South Temple, Salt Lake City, UT, 84111, US

(73) Assignee: ALTEK CORPORATION, Hsinchu (TW)

(21) Appl. No.: 12/344,813

(22) Filed: Dec. 29, 2008

(30) Foreign Application Priority Data
Dec. 26, 2007 (TW) 096150368

(51) Int. Cl. G06K 9/00

(52) U.S. Cl. 382/118

(57) ABSTRACT

Face detection and tracking method is executed by a computer or a microprocessor with computing capability for identifying human faces and positions thereof in image frames. First, face detection is performed to detect human faces in a plurality of frames. Then, face tracking is performed on each of the frames to track the detected human faces and record positions of these human faces. Afterward, face detection on the image frames is again performed every few frames, skipping the positions of the human faces that have been recorded, so as to quickly search for other human faces that might be newly added.

### CROSS-REFERENCE TO RELATED APPLICATIONS

This non-provisional application claims priority under 35 U.S.C. §119(a) on Patent Application No(s). 096150368 filed in Taiwan, R.O.C. on Dec. 26, 2007 the entire contents of which are hereby incorporated by reference.

### BACKGROUND OF THE INVENTION

1. Field of Invention

The present invention relates to an image detection method, and more particularly to a method of quickly searching for human faces that might be newly added in an image frame.

2. Related Art

In our daily life, digital video-camera devices are used to shoot portraits and scenes, or video-camera modules of Web CAMs or mobile phones are used to perform real-time video conferences. Digital video-camera equipments such as Web CAMs, digital videos (DVs), monitoring video-cameras, or video-camera modules of mobile phones/cameras are all commonly adopted nowadays. Among captured images, figure images are the core of image shooting. For example, when a DV is used to shoot a dinner party, as people participating in the party shuttle back and forth, the photographer needs to frequently adjust the shooting focal length to maintain human faces of most people in the frames clear. Some digital video-camera equipments are provided with automatic focusing functions to help shoot clear images. In addition, some digital video-camera equipments are further provided with face determination and tracking techniques to assist automatic multi-focusing of the shot area. Human face tracking techniques have appeared for years. For example, “System and Method of Quickly Tracking Multiple Faces” is disclosed in R.O.C. Patent Publication No. 00505892 in 2002, which finds out regions, that human faces might exist according to colors and profile features of blocks. In addition, “ATM Monitoring System for Preventing False Claims and Issuing Early Warning Mainly Relying on Neural Network” is disclosed in R.O.C. Patent No. 1245205 in 2005 provides a technique of applying face recognition in an ATM.

At present, face detection and tracking techniques are usually carried out by the following methods. In one method, first, face detection is actuated, then a face tracking is performed after human face features in a plurality of frames are detected, and a face detection will not be actuated again until the face tracking fails. The disadvantages of the above method are: it usually takes a long time to find out newly added human face features; and during face detection, if new human faces are added; it is unable to track these newly added human faces. In another method, face detection is carried out every few frames of a fixed number, and a face tracking is performed on the whole range of the rest of the frames. The disadvantages of the above method are: the face detection is rather time-consuming and requires considerable computing resources.

### SUMMARY OF THE INVENTION

Accordingly, in order to overcome the above disadvantages that the process of face detection and tracking requires considerable computing resources and it usually takes a period of time to find out newly added human faces, the present invention is directed to a face detection and tracking method. According to the method, a face detection and a tracking of positions of the detected human faces are performed regularly, while skipping the blocks of the human faces already found during the face detection, such that the time required by face detection and tracking is shortened, and newly added human faces can be rapidly searched for.

In order to achieve the above objective, a face detection and tracking method is designed and carried out by a computer to identify positions of faces in shot frames. The face detection and tracking method includes the following steps. First, face detection is performed to detect human faces in a plurality of frames. Then, a face tracking is performed on each of the frames to track the detected faces and record positions of these human faces. Finally, a face detection is performed again every few frames, skipping the positions of human faces that have been recorded, so as to quickly search for newly added human faces.

In the face detection and tracking method according to a preferred embodiment of the present invention, the face detection includes the following steps: (a), performing an edge detection respectively on the frames to obtain an edge image; (b) dividing the edge image into structures with blocks of equal sizes according to dimensions of human face features; and (c) comparing each of the blocks in the edge image to see whether any images matching the human face features exist. Additionally, a face feature database is created according to a number of distinct face features of different sizes. The edge image is then sequentially divided into structures with blocks of equal sizes according to dimensions of the human face features of unequal sizes. Afterward, the above steps (a), (b), and (c) of face detection are sequentially performed according to these human face features to find out the face images matching these face features.

In the face detection and tracking method according to a preferred embodiment of the present invention, the face tracking is performed by, for example, an image differencing method, a moving edge detection method, or a trust-region method. The image differencing method compares to see a pixel difference between a current frame and a previous one, so as to find out the positions of the face images after moving. The moving edge detection method obtains a pixel difference between a current frame and a previous frame (and a pixel difference between the previous two frames) and obtains the positions of the faces after moving through processes like edge treatment. The trust-region method searches in a preset range around corresponding positions in a current frame according to the positions of the human faces in a previous frame to see whether any human face images matching the human face features exist, and records the positions of the human face images.

In view of the above, the present invention first detects the newly added/already existing human faces, then tracks the detected human faces, and skips the positions of the already existing/found human faces during the face detection, such that the time required by face detection and tracking is shortened, and newly added human faces can be rapidly searched for.

### BRIEF DESCRIPTION OF THE DRAWINGS

The present invention will become more fully understood from the detailed description given herein below for illustration only, and thus are not limitative of the present invention, and wherein:

FIG. 1 is a flow chart of face detection and tracking method;

FIG. 2A is a schematic view of a thread of the face detection and tracking method;

FIG. 2B is another schematic view of a thread of the face detection and tracking method;

FIG. 2C is still another schematic view of a thread of the face detection and tracking method;

FIG. 3A shows an image on which the face detection is to be performed;

FIG. 3B is a schematic view of carrying out the face detection;

FIG. 3C is a schematic view of face tracking; and

FIG. 3D is a schematic view of carrying out the face detection and tracking method.

### DETAILED DESCRIPTION OF THE INVENTION

The objective and face detection and tracking method of the present invention are described in detail below with preferred embodiments, and the concept of the present invention may also be applied to other scopes. The embodiments below are only used to illustrate the objective and method of the present invention, instead of limiting the scope of the same.

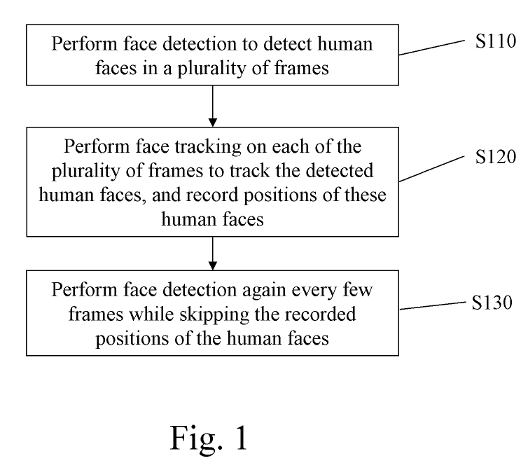

FIG. 1 is a flow chart of face detection and tracking method. Referring to FIG. 1, in a preferred embodiment of the present invention, for example, a DV is used to shoot images, and the face detection and tracking method is carried out by a DSP chip or a microprocessor in a digital camera to identify positions of faces in the shot frames. The face detection and tracking method includes the following steps. First, face detection is performed to detect faces in a plurality of frames (Step S110). Then, a face tracking is performed on each of the frames to track the detected faces and record positions of these faces (Step S120). Afterward, a face detection is again performed every few frames, skipping the positions of the human faces that have been recorded (Step S130), so as to quickly search for other human faces that might be newly added.

In this embodiment, the face detection includes the following steps of (a), (b), and (c). In Step (a), edge detection is respectively performed on the frames to obtain an edge image. At present, the edge detection is usually performed by, for example, the method of Gradient Magnitude, Laplacian, Tengengrad, or ID Horizontal Filter. This embodiment, for instance, performs a 2D gradient transform on an image (for example, multiplying the image pixels by a 2D gradient matrix), and obtains the edge image by operation. In Step (b), the edge image is divided into structures with blocks of equal sizes according to dimensions of face features. A system for carrying out the face detection and tracking method described by this embodiment creates a human face feature database. For example, the system has already built with three distinct human face features of different dimensions. Thus, the edge image is divided into blocks of three levels according to the dimensions of these human face features. Afterward, the edge image is sequentially divided according to these blocks of different levels to obtain a number of blocks of equal sizes. For example, if the block sizes of the three face features are respectively 30*30 pixels, 60*60 pixels, and 120*120 pixels, the edge image is divided into a structure with a number of blocks of 30*30 pixels, a structure with a number of blocks of 60*60 pixels, and a structure with a number of blocks of 120*120 pixels. In Step (c), each of the blocks in the edge image is compared to see whether any images matching the foregoing face features exist. For example, for the above database built with three distinct human face features of different dimensions, the comparison needs to be performed three times on the full frame according to the three face features stored in the database. First, it is determined by comparing each of the blocks of 30*30 pixels in the edge image one by one with the human face feature of 30*30 pixels to see whether any human face images matching the 30*30 pixels exist. Then, it is determined by comparing each of the blocks of 60*60 pixels in the edge image one by one with the human face feature of 60*60 pixels to see whether any human face images matching the 60*60 pixels exist. Finally, it is determined by comparing each of the blocks of 120*120 pixels in the edge image one by one with the human face feature of 120*120 pixels to see whether any face images matching the 120*120 pixels exist.

After all human faces existing in the frames are detected, the detected human faces are tracked and the positions thereof are recorded. Then, the principle of determining human face motions is illustrated as follows: for images shot in the same region, if no difference exists between the pixels of two frames shot in time sequence, it is determined that objects in the region have not moved; otherwise, it is determined that objects in the region have moved and the positions thereof after the movement can be figured out. With this principle, the positions of the tracked human face images can be rapidly determined and recorded. In this embodiment, the face tracking is performed by, for example, an image differencing method, a moving edge detection method, or a trust-region method. The image differencing method compares to see the pixel difference between a current frame and a previous one, so as to find out the positions of the tracked human face images after moving. The moving edge detection method compares to see the pixel difference between a current frame and a previous one, so as to obtain a first differential frame (and compares to see the pixel difference between the previous two frames to obtain a second differential frame); then, performs an edge treatment on the first and second differential frames; and afterward multiplies the treated first and second differential frames to obtain the positions of the face images after moving. While the trust-region method, according to the positions of the face images in the previous frame, searches in a preset range around corresponding positions in the current frame to see whether any human face images matching the human face features exist, and obtains the positions of the human face images after moving.

Additionally, the face detection needs to sequentially compare the images in the frames according to various human face features, so as to detect all the images matching these human face features. However, this process requires considerable computing resources, and may easily cause image processing delay as the face detection is carried out on the same frame (a user will sense unsmooth image motions). To alleviate the computing load on the face detection, the face detection and tracking method further includes simultaneously performing face detection and face tracking in a thread and distributing the comparison of a number of human face features required by the face detection into several frames. The steps (a), (b), and (c) of face detection are performed on a single frame according to only one human face feature so as to find out human face images matching the human face feature. In this manner, the computing load is alleviated and the image processing delay may be avoided.

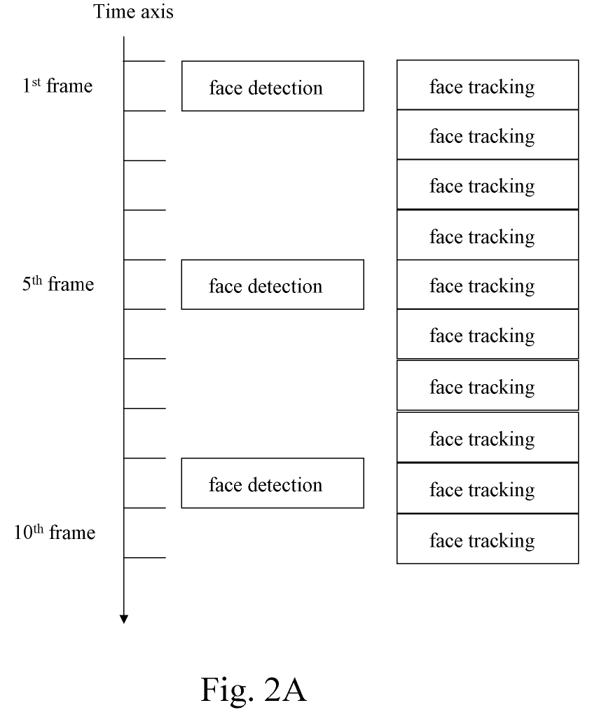

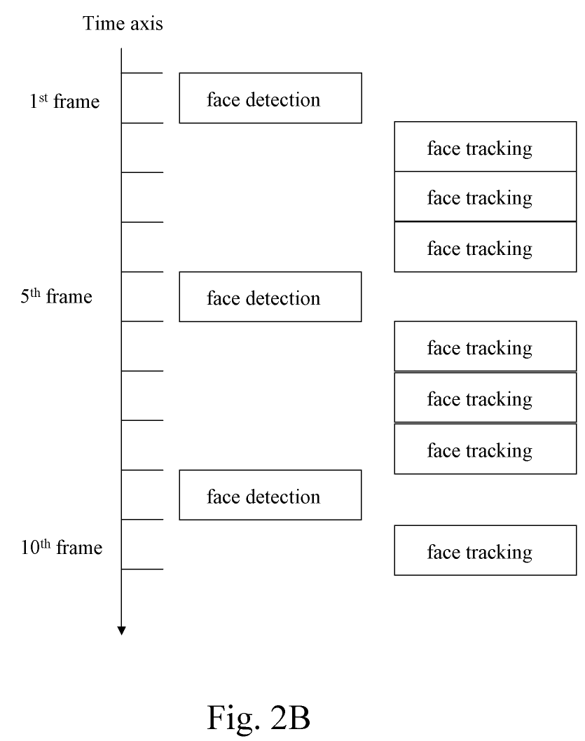

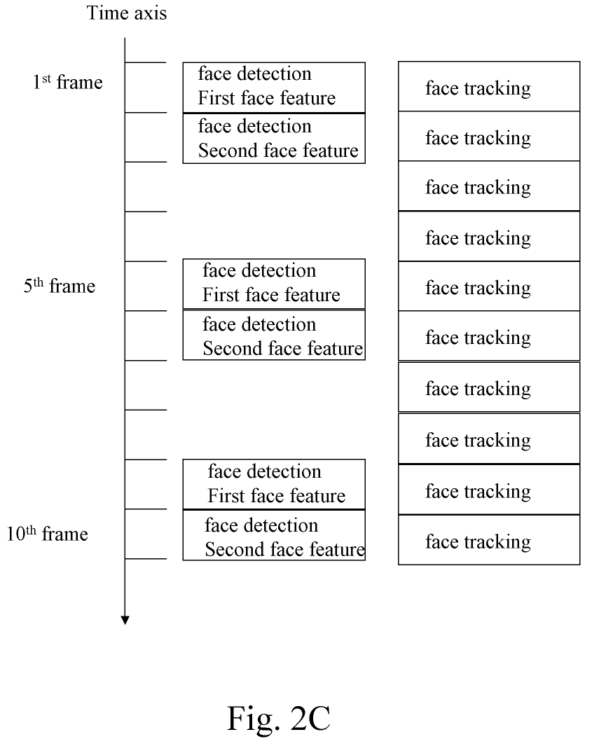

In order to describe the face detection and tracking method more clearly, another preferred embodiment is given below for illustration. FIG. 2A is a schematic view of a thread of the face detection and tracking method. Referring to FIG. 2A, the left longitudinal axis represents a time axis of images in a unit of a frame (i.e., the time for processing a frame). Face detection is performed on a first frame (1^{st} frame). Thereafter, the face detection is performed again every few frames (in this embodiment, face detection is performed, but not limited to, every other three frames) to detect newly added human faces and record positions of these human faces. Meanwhile, a face tracking is performed on each of the frames to continue tracking the detected human faces. The implementations of the face detection and face tracking have been described in detail afore, and will not be repeated herein again.

In some embodiments, due to the fact that considerable computing resources are required by the face detection, the face tracking is not preformed simultaneously with the face detection. FIG. 2B is another schematic view of a thread of the face detection and tracking method. Referring to FIG. 2B, the face detection is performed on the 1^{st}, 5^{th}, and 9^{th} frames, and the face tracking is performed on the rest of the frames.

In some other embodiments, to alleviate the computing load for carrying out the face detection, the detection is performed on a single frame according to only one face feature. FIG. 2C is still another schematic view of a thread of the face detection and tracking method. Referring to FIG. 2C, in this embodiment, when the face detection and tracking is performed, a thread is actuated to simultaneously carry out the face detection and the face tracking, and only human face images matching human face features are detected from the same frame in the face detection. For example, this embodiment detects a first human face feature and a second human face feature, then carries out the above face detection on the 1^{st}, 5^{th}, and 9^{th} frames according to the first human face feature to find out in the frames human face images matching the first human face feature, and carries out the above face detection on the 2^{nd}, 6^{th}, and 10^{th} frames according to the second human face feature to find out in the frames human face images matching the second human face feature. This embodiment, for example, performs a detection of a single human face feature on a single frame. However, depending on the computing capability of the computer or microprocessor for carrying out the face detection and tracking method, detection and comparison processes for more than two human face features can also be performed on the same frame. Thereby, the number of human face features to be processed in a single frame is not limited herein.

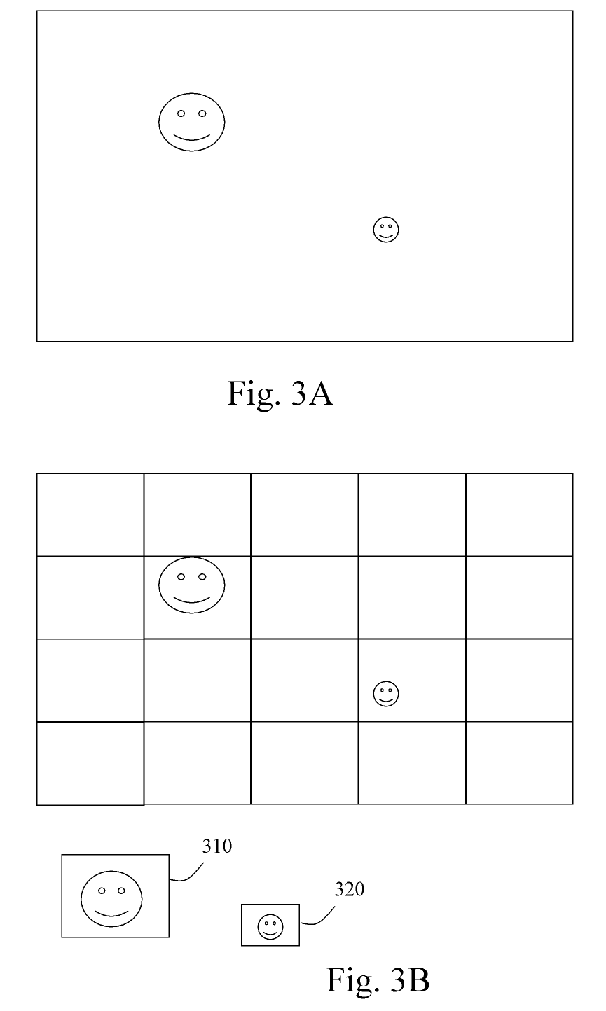

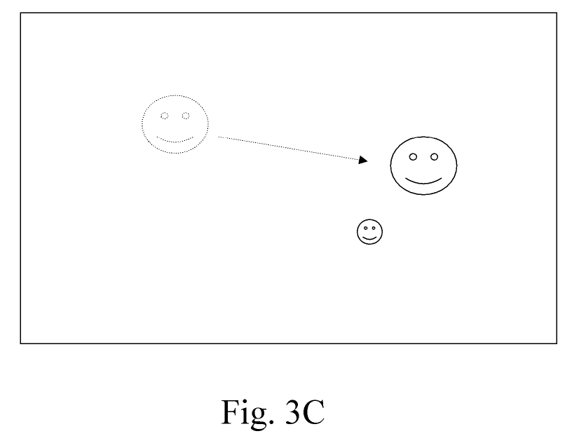

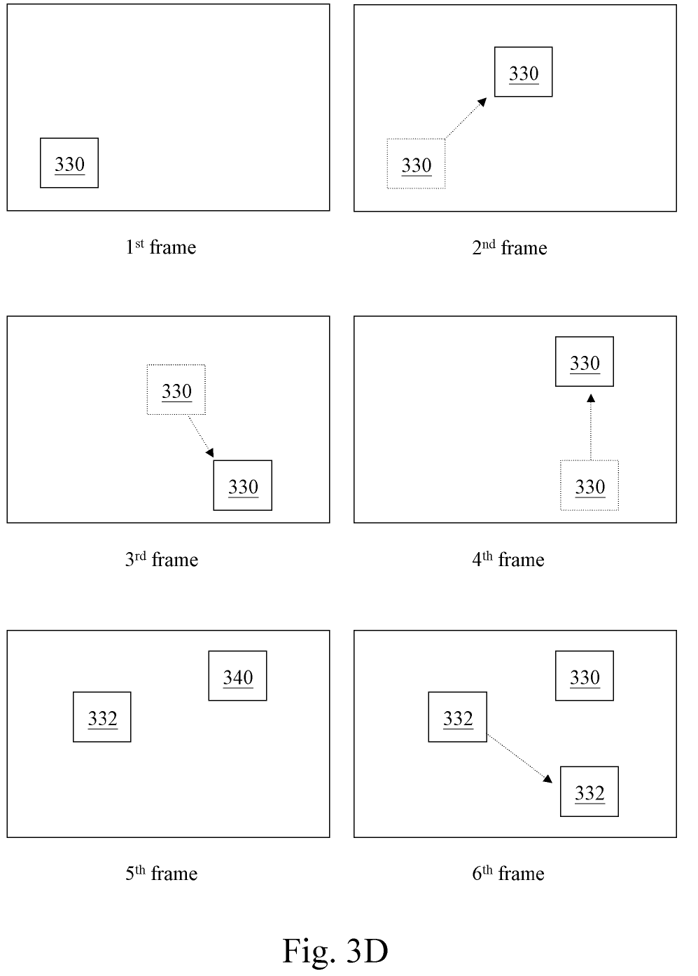

In another preferred embodiment, how the face detection and tracking method accelerates the face detection will be illustrated with the drawings. FIG. 3A shows an image on which the face detection is to be performed. FIG. 3B is a schematic view of carrying out the face detection. Referring to FIGS. 3A and 3B together, in still another preferred embodiment, first, an edge treatment is performed on the image to be detected (FIG. 3A) to obtain an edge image. Then, the edge image is divided into structures with a number of blocks of equal sizes according to the dimension of a first human face feature (as shown in FIG. 3B). Each of these blocks is compared one by one, and an image matching the first human face feature is found in a block of Column 2 and Row 2. After all the blocks are compared, the edge image is further divided into structures with a number of blocks of equal sizes according to the dimension of a second human face feature (not shown). Then, the blocks are compared according to the second human face feature, and a human face image matching the second human face feature is found in a block of Column 4 and Row 3 as shown in FIG. 3B. After the positions of all the human face features in the images are found, a face tracking is performed to track the motion of the human face images. Referring to FIG. 3C, the face tracking may be carried out by, for example, an image differencing method, a moving edge detection method, or a trust-region method. The principles and operations of these methods have been described in detail afore, and will not be repeated herein again.

FIG. 3D is a schematic view of carrying out the face detection and tracking method. Referring to FIG. 3D, first, a human face is detected in a first frame and the region is set to be a human face block 330. Afterward, a face tracking is preformed on the 2^{nd}, 3^{rd}, and 4^{th} frames to track the motion of the human face block 330 and record positions of the human face block 330 after moving. When the 5^{th} frame is to be processed, a face detection is performed again. First, the human face block 330 tracked in the 4^{th} frame is set as a skipped block 340 on which the face detection will be no longer performed. Thereby, during the face detection, the skipped block 340 will not be detected to see whether any newly added human face images exist, and only regions other than the skipped block 340 in the frame need to be detected. Referring to the 5^{th} frame, the frame is detected to see whether any human face image matching a number of preset human face features exists and such a human face image is set as a human face block 332. Finally, a face tracking is performed on the 6^{th} frame to continue tracking the motions of the human face blocks 330 and 332.

What is claimed is:

1. A face detection and tracking method, carried out by a computer or a microprocessor with computing capability, the method comprising:
performing a face detection to detect human faces in a plurality of frames;
performing a face tracking on each of the plurality of frames to track the detected human faces and record positions of the human faces; and
performing a face detection again every few frames while skipping the recorded positions of the human faces.

2. The face detection and tracking method as claimed in claim 1, wherein the face detection comprises:
(a) performing an edge detection respectively on the frames to obtain an edge image;
(b) dividing the edge image into structures with blocks of equal sizes according to dimensions of human face features; and
(c) comparing each of the blocks in the edge image to see whether any images matching the human face features exist.

3. The face detection and tracking method as claimed in claim 2, wherein the face detection further comprises:
sequentially dividing the edge image into structures with blocks of equal sizes according to dimensions of a number of human face features of unequal sizes; and
sequentially carrying out the steps (a), (b), and (c) of face detection according to the human face features, so as to find out the images matching the human face features.

4. The face detection and tracking method as claimed in claim 3, further comprising: simultaneously performing a face detection and a face tracking in a thread, the face detection compares in the frames the images matching the human face features, and the steps (a), (b), and (c) of face detection are performed on a single frame according to only one human face feature.

5. The face detection and tracking method as claimed in claim 1, wherein the face tracking is performed by a method selected from a group consisting of an image differencing method, a moving edge detection method, and a trust-region method.

6. The face detection and tracking method as claimed in claim 5, wherein the image differencing method compares to see a pixel difference between a current frame and a previous one, so as to find out the positions of the human face images after moving.

7. The face detection and tracking method as claimed in claim 5, wherein the moving edge detection method comprises:
obtaining a pixel difference between a current frame and a previous one as a first differential frame, and performing an edge treatment on the first differential frame;
obtaining a pixel difference between the previous two frames as a second differential frame, and performing an edge treatment on the second differential frame; and
multiplying the treated first and second differential frames to obtain the positions of the human faces after moving.

8. The face detection and tracking method as claimed in claim 5, wherein the trust-region method searches in a preset range around corresponding positions in a current frame according to the positions of the human faces in a previous frame to see whether any human face images matching the human face features exist, and records the positions of the human face images.
